(19) United States
(12) Patent Application Publication
(10) Pub. No.: US 2026/0014628 A1
(43) Pub. Date: Jan. 15, 2026

(54) SYSTEMS AND METHODS FOR PIEZO-DRIVEN JETTING OF POWDERS FOR CONTROLLED PACKING DENSITY IN ADDITIVE MANUFACTURING APPLICATIONS

(71) Applicant: Lawrence Livermore National Security, LLC, Livermore, CA (US)

(72) Inventors: Joshua R. DEOTTE, San Ramon, CA (US); Drew Shrader MELCHERT, Livermore, CA (US); Michael John TROKSA, Pleasanton, CA (US)

(21) Appl. No.: 18/889,853

(22) Filed: Sep. 19, 2024

Related U.S. Application Data
(60) Provisional application No. 63/542,035, filed on Oct. 2, 2023.

(51) Int. Cl. B22F 12/60; B22F 10/14; B22F 10/37; B22F 10/85; B22F 12/53; B33Y 10/00; B33Y 30/00; B33Y 50/02

(52) U.S. Cl. CPC B22F 12/60; B22F 10/14; B22F 10/37; B22F 10/85; B22F 12/53; B33Y 10/00; B33Y 30/00; B33Y 50/02

(57) ABSTRACT

The present disclosure relates to a system for selective powder deposition (SPD) printing a part or structure. In one embodiment the system makes use of a print nozzle having a nozzle tip portion. A vibrational element is associated with the nozzle tip portion and receives an excitation signal from an excitation subsystem and generates vibrational energy which is imparted into the powder particles within the print nozzle. The vibrational element imparts the vibrational energy to the powder particles as they are deposited, which assists in compacting the powder particles.

### CROSS-REFERENCE TO RELATED APPLICATIONS

This application claims the benefit of U.S. Provisional Application No. 63/542,035, filed on Oct. 2, 2023. The entire disclosure of the above application is incorporated herein by reference.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to additive manufacturing systems and methods, and more particularly to systems and that provide a significantly improved packing fraction of the powder being used during an additive manufacturing extrusion printing process to form a part, which enables a significant reduction in part porosity, and further eliminates or significantly reduces slumping of features of the printed part, and still further enables the printing process to be carried out without the use of a binder, and without the need to sinter or melt each layer of the part as the part is being printed.

### BACKGROUND

The statements in this section merely provide background information related to the present disclosure and may not constitute prior art.

The present disclosure is broadly related to the subject matter of U.S. Pat. No. 11,697,246 to Dudukovic et al., which is assigned to the assignee of the present application. The teachings of this patent are hereby incorporated by reference into the present application.

Additive manufacturing (AM) of metal and ceramic materials is in high demand in industries where geometrically complex parts need to be produced quickly and with high precision, where conventional manufacturing requires tooling that is currently slow and expensive. In these applications there is often demand for multi-material components, for example, multi-material components which are specifically tailored to conduct heat flow in turbine components, to provide locally enhanced wear resistance, or to provide chemical resistance, just to name a few areas of specific interest. A manufacturing technology that is capable of producing multi-material parts with a wide degree of geometrical versatility would open doors for feasibility of next-gen technologies of many kinds.

Two well-known AM methods for producing parts from a material in granular form include Powder Bed Fusion (PBF) and Binder Jetting. Both of these methods typically make use of a system comprising of a storage chamber for unused material, a print chamber, and a rolling or blade mechanism for powder spreading. They may use different additives for the formation of a stable structure in a layer-by-layer build process. Powder Bed Fusion methods make use of a focused energy source to either melt or sinter the granular material on the build substrate. In contrast, Binder Jetting typically employs a liquid binder to bond the material. While the use of a binding mechanism is effective for building up multiple layers, deploying this method for structure formation often leads to undesired qualities of the final part being built. These undesired qualities can involve uneven part shrinkage (25% or possibly more) of the final part, part slumping and other defects. In addition, finished parts often have significant undesirable porosity (e.g., binder jet aims for 50-64 vol %, often less) since there is limited means to control the packing of powder during printing.

In addition, the above methods are designed for spreading a single powder; options for incorporating multi-material capability are limited in conventional powder spreading technology, prompting exploration into other powder deposition approaches like vibration-assisted selective powder deposition in the context of selective laser sintering (SLS) and/or selective laser melting (SLM). This has also been studied in other contexts, e.g., micro powder feeding for bio dosing. These approaches are all 2D approaches where a single layer of powder is deposited before binding or sintering, which is an effective solution to adding capability for multi-material printing.

At present, there is a growing demand for methods that have better control of the packing fraction of printed powder. Improved control over the packing fraction will reduce porosity, slumping and defects, which are some of the primary limiting factors of the mechanical properties of AM metal. Improved packing fraction will lower material waste, which is presently a significant barrier to industrial adoption. Furthermore, local control of packing fraction (i.e., modulating packing during printing) will allow useful properties like porosity gradients, e.g., for engineered heat transport or compensation for variable compression throughout a part if, printed green bodies are subsequently hot-pressed. Being able to create parts with high volume fractions also enables freestanding powder structures without the use of binder, such that printed structures can be directly hot-pressed or processed in other ways.

Deposition of densely packed, freestanding binder-less powder structures has up until the present time received very little investigation. The conventional understanding is that only non-flowing (very cohesive) powders can achieve angles of repose greater than about 55°, where 90° is needed for straight-walled, freestanding structures. This means that the walls of printed lines will collapse using any flowable (printable) powder, resulting in few attempts in literature at 3D deposition of binder-less powders. These results, however, are obtained by dropping powders from a height. An alternate approach, where powder is packed during or after deposition, without loss of structure in a rapid, high-resolution process, was determined to be possible by the inventors. Increased packing density also directly increases the steepness of deposited walls, because increasing consolidation stress increases cohesive forces between particles, which in turn increases wall steepness.

The method to accomplish packing during deposition was inspired by industrial processes. In contexts outside of AM, several studies have also shown that packing densities greater than 0.64 can be achieved via vibrating containers of powder. However, the on-going challenge has been to apply highly controlled vibrational energy to powder deposited on a substrate (i.e., not enclosed in a container as with previously systems and methods) without disturbing the geometry of the printed structure.

### SUMMARY

This section provides a general summary of the disclosure, and is not a comprehensive disclosure of its full scope or all of its features.

In one aspect the present disclosure relates to a system for selective powder deposition (SPD) printing a part. The system may comprise a print nozzle configured to receive powder particles. The print nozzle has a tip portion from which the powder particles are released onto a build table. A vibrational element is included which is operably associated with the tip portion of the nozzle and configured to impart a vibrational energy into the powder particles within the print nozzle. An excitation subsystem is included which is configured to generate an excitation signal of a predetermined frequency. The excitation signal is applied to the vibrational element to create the vibrational energy. The vibrational energy is also imparted to the powder particles as the powder particles are being released onto the build table to compact the powder particles as the powder particles are deposited onto the build table.

In another aspect of the present disclosure the system further comprises an electronic controller for controlling the excitation subsystem.

In another aspect of the present disclosure the In another aspect of the present disclosure a lower end of the tip portion of the print nozzle is disposed within 1-10 multiples of a diameter of the powder particles of the build table during printing. This assists in enabling the powder particles to be compacted before reaching the build table.

In another aspect of the present disclosure the system further comprises a fluid vaporizer for applying a fluid mist to the powder particles deposited on the build table.

In another aspect of the present disclosure the excitation subsystem comprises an excitation subsystem for generating an alternating current (AC) excitation signal.

In another aspect of the present disclosure the excitation signal comprises an AC signal having a frequency between about 100 Hz and 1 KHz.

In another aspect of the present disclosure the excitation signal has a magnitude of between 100 VAC and 200 VAC.

In another aspect of the present disclosure the vibrational element comprises a piezoelectric element.

In another aspect of the present disclosure the piezoelectric element comprises an annular shape and is supported from the nozzle tip portion, exteriorly of the nozzle tip portion, and coaxially with the nozzle tip portion.

In another aspect of the present disclosure the system further comprises a nozzle motion control subsystem configured to control motion of the nozzle in X, Y and Z axes in response to electronic control signals from the electronic controller.

In another aspect of the present disclosure the system further comprises an electronic controller for generating electronic control signals for controlling the nozzle motion control subsystem.

In another aspect of the present disclosure the electronic controller further comprises a memory.

In another aspect of the present disclosure the memory stores software modules for generating G-code for printing the structure, and at least one of algorithms or data needed for printing the part.

In another aspect the present disclosure relates to a system for selective powder deposition (SPD) printing a part. The system may comprise an electronic controller, a hopper for containing a quantity of powder particles, and a print nozzle. The print nozzle may be in communication with the hopper and configured to receive the powder particles. The print nozzle has a tapering syringe portion and a barrel-like, cylindrical tip portion from which the powder particles are released onto a build table. A vibrational element is included which is operably associated with the nozzle and configured to apply vibrational energy to the powder particles contained in the nozzle. This controls the release of the powder particles from the nozzle tip portion. An excitation subsystem is included which is responsive to control signals from the electronic controller, and configured to generate an excitation signal of a predetermined frequency and magnitude, which is applied to the vibrational element to cause generation of the vibrational energy. The tip portion of the nozzle is set at a distance of about 1-10 multiples of a diameter of the powder particles from the surface of the build table, to further enable the vibrational energy to be imparted to the powder particles and compacting the powder particles as the powder particles are deposited.

In another aspect of the present disclosure the system further comprises a fluid vaporizer for applying a fluid mist to the powder particles deposited on the build table.

In another aspect of the present disclosure the excitation subsystem comprises an excitation subsystem for generating an alternating current (AC) excitation signal.

In another aspect of the present disclosure the excitation signal comprises an AC signal having a frequency between about 100 Hz and 1 KHz.

In another aspect of the present disclosure the excitation signal has a magnitude of between 100 VAC and 200 VAC.

In another aspect of the present disclosure the vibrational element comprises a piezoelectric element.

In still another aspect the present disclosure relates to a method for printing a part. The method may comprise using a print nozzle to receive powder particles to be printed on a build table to make the part. The method may further include applying an excitation signal to a vibrational element operably associated with the tip portion of the nozzle to impart vibrational energy into the powder particles contained within the print nozzle, to assist in controlling release of the powder particles from the print nozzle. The method may further include maintaining a tip portion of the print nozzle at a predetermined distance from the build table as the nozzle is moved over the build table and deposits a bead of the powder particles. The predetermined distance is sufficiently small to enable the vibrational energy to also compact the powder particles as the powder particles are deposited onto the build table.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level block diagram of one example of a system in accordance with the present disclosure for depositing powders in a manner that allows 3D structures having a wide range of structural features to be additively manufactured (i.e., 3D printed) by packing a powder feedstock as the powder feedstock is being deposited on a substrate, so that the 3D structure can be fully formed, and is suitable for transport by hand, without a further heat treatment or curing operation.

FIG. 2 is a highly enlarged partial side cross-sectional view of the nozzle shown in FIG. 1; and

FIG. 3 is a high level flowchart illustrating basic operations that may be performed in carrying out a method of the present disclosure.

### DETAILED DESCRIPTION

Example embodiments will now be described more fully with reference to the accompanying drawings.

The present disclosure overcomes the limitations of previous attempts at improving packing density art by confining deposited powder in a thin layer between the substrate and a vibrating nozzle. Vibration energy is applied which is engineered to simultaneously control powder flow (as in previous powder deposition art), but yet to rearrange and compress deposited particles into an even significantly more densely packed state. The systems and methods disclosed herein effectively increase packing fraction sufficiently to form novel freestanding structures with vertical walls using pure, binder-free metal powders. Furthermore, parameters can be tuned to modulate the packing fraction during printing, allowing spatial gradients in porosity to be achieved in the finished part.

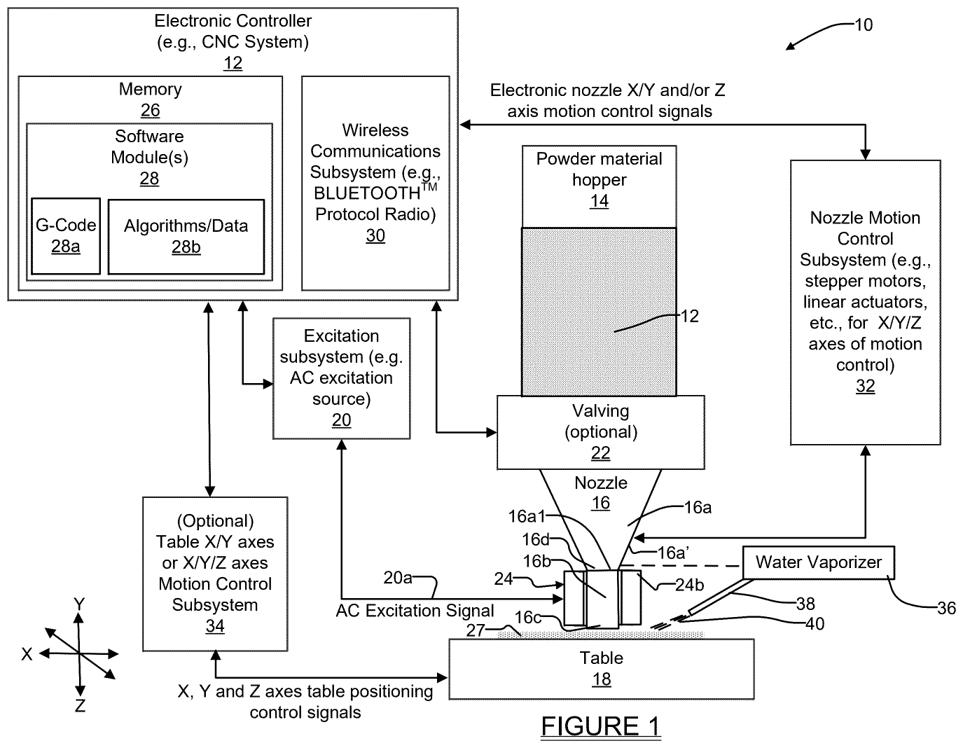

Referring briefly to FIG. 1, one example of a system 10 is shown in accordance with the present disclosure. The system 10 in this example includes an electronic controller 12 (hereinafter simply “controller”), which in various embodiments may take the form of, for example, a desktop computer, laptop computer, personal electronic device or virtually any other form of microprocessor-based controller). The controller 12 may be used for controlling an application of feedstock powder 12 contained in a hopper 14, in some embodiments a stainless steel hopper, through a nozzle 16 and onto a build table 18. The nozzle 16 in this example has a syringe portion 16a which has a tapering sidewall 16a′, and a tubular, barrel-like nozzle portion 16b. The flow of powder 12 into the nozzle 16 may be controlled in some embodiments by an electronically responsive valving subsystem 22 controlled at least in part by control signals from the controller 12. In some embodiments the valving subsystem 22 may not be needed. If more than one type of feedstock material 12 is being used, then the valving subsystem 22 may be helpful in selecting specific powders to be used at specific points during the printing process.

The system 10 also includes an excitation subsystem 20, which in some embodiments may be an AC signal source of predetermined frequency and voltage, for generating an excitation signal 20a. In some embodiments the excitation signal 20a may be an AC excitation signal. In some embodiments the AC excitation signal may be of a voltage between about 100 VAC-200 VAC, and in some embodiments about 150 VAC. In some embodiments the frequency of the AC excitation signal may be between about 100 Hz to about 1 KHz. The optimal amplitude and frequency of the excitation signal 20a may depend at least in part on the physical characteristics and makeup of the powder 12, a dimension of a tip 16c of the nozzle 16, a rate of movement in any one of the X, Y and/or Z planes of the nozzle 16 during a printing operation, a spacing of the nozzle tip 16c from the table 18 or previously laid down material layer, and a variety of other factors that will be appreciated by those skilled in the art.

The excitation signal 20a is applied to a vibrational element 24. In some embodiments the vibrational element 24 comprises an annular, stacked piezoelectric element which is disposed and supported outside the nozzle portion 16b so as to be at or closely adjacent the nozzle tip 16c. Merely for convenience, the vibrational element 24 will be referred to throughout the following discussion as “piezoelectric element 24”. The precise shape and dimensions of the piezoelectric element 24 may vary depending on the shape and/or dimension of the opening at the nozzle tip 16a, the type of feedstock powder being used and other factors. The vibrational element 24 causes a highly controlled bead 27 of the powder 12 to be deposited on the table 18 as nozzle 16 (or the table 18) is moved.

The controller 12 may include a memory 26 (e.g., non-volatile RAM/ROM, DRAM, EPROM, etc.) for holding one or more software module 28. The software module(s) 28 may include a G-code generating module for generating G-code for printing a part on the table 18, as well as algorithms and/or data needed for controlling the printing process. Such algorithms and/or data may include look-up tables, data curves, stored data or other information which is needed or helpful in controlling the printing operation carried out by the system 10. Optionally a wireless communications subsystem 30 may be included for communicating wirelessly with a network or other external electronic device. In one embodiment a BLUETOOTH® protocol radio may be included for wirelessly communication with a remote external personal electronic device. Optionally, the electronic controller 12 may also have an internal network adapter which enables wired communication with a local area network, which in turn enables communication between the controller 12 and a wide area network (not shown).

With further reference to FIG. 1, the system 10 may also include a nozzle motion control subsystem 32 which is responsive to control signals from the controller 12 for controlling movement along the X, Y and Z axes to carry out a printing operation. The nozzle motion control subsystem 32 may include one or more DC stepper motors, linear actuators or other components for achieving the needed resolution of movement of the print nozzle 16 in each of the X, Y and Z planes. Optionally, if it is desired to maintain the nozzle 16 stationary during printing, then a motion control subsystem 34 may be used to control motion of the table 18 in at least the X and Y axes, and optionally in all three of the X, Y and Z axes. In some embodiments movement of the nozzle 16 may be carried out in one or two of the X, Y and Z axes, while the table is movement in the other one (or two) of the X, Y and Z axes. It is anticipated that movement of the nozzle 16 along each of the X, Y and Z axes is likely to be particularly preferred, but the present disclosure is not limited to moving only the nozzle 16 or only the table 18.

Referring further to FIG. 1, in some embodiments the system 10 may further include a fluid vaporizer 36, which in one particular embodiment may be a water vaporizer (hereinafter simply “water vaporizer 36”). It will be appreciated immediately, however, that water is not the only fluid that is suitable for use, and other fluids, for example and without limitation oils, or solvents for particle constituents may be used as well. The specific powder being used for printing and other variables may have a bearing on the specific fluid selected. If water is used, then the water may simply be kept at an ambient (e.g., room) temperature. Merely for convenience, water will be the fluid that is used for the following discussion of the water vaporizer 36.

The water vaporizer 36 may include a hose 38 for directing a very fine mist of water 40 (or other fluid) towards the powder 12 deposited on the table 18 as printing is taking place. The mist may be continuous or intermittently pulsed (e.g., every few 30 seconds or once per layer. This creates a high humidity environment around the deposited powder 12 but keeps the powder in the hopper 14 and nozzle 16 dry, and thus flowable, thus preventing clogging. The water vapor is adsorbed onto the deposited powder 12 forming the bead 27, which increases cohesive forces between powder particles of the bead 27 and keeps the powder particles making up the printed structure held to together during the printing process with high volume fraction without collapsing. In some embodiments a very fine water droplet size, typically much less than the powder size, is required to prevent disruption of the printed structure. The volume fraction of ceramic nano-powder using this method was measured to be 47%, whereas the volume fraction for the same powder without vibration and scraping previous layers is 33%. This gives the capability for a large gradient in packing density during printing. In addition, some nano-powders benefit from agglomeration into a larger secondary particle size to increase flowability but still retain the benefits of nano-sized primary particles (e.g., sintering at lower temperature or high reactivity).

Further to the above, it should be appreciated that for some applications, for example SPD (Selective Powder Deposition) printing into molds, which is particularly useful in some applications, a benefit can exist from submerging the nozzle 16 into the deposited powder 12 during printing to fill voids near mold walls. In this example of printing into a mold, the system 10 is not printing a freestanding structure, but nevertheless enables filling molds with high packing density. This also provides the capability to vary packing fraction throughout a part, allowing for correction of variation caused by hot pressing or engineered gradients.

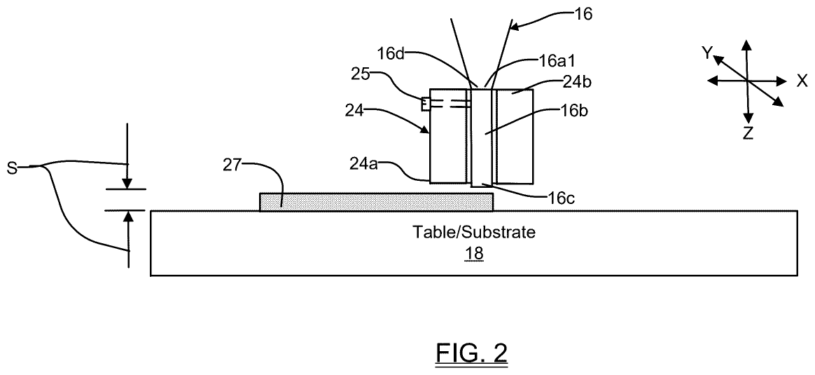

Referring to FIG. 2, a highly enlarged, side, cross-sectional view of the nozzle 16 is shown. The feedstock powder 12 within the interior of the nozzle 16 is not shown in this illustration so as to better show the piezoelectric element 24. A lower end 24a of the piezoelectric element 24 is positioned at or closely adjacent (e.g., typically within a few thousands of an inch) of the opening at the nozzle tip 16c, or located further up the nozzle (an inch or more) so long as the tip opening is physically coupled to the actuator tightly enough that it vibrates with sufficient displacement to rearrange and densify the deposited powder. Preferably, an upper end 24b of the piezoelectric element 24 is disposed at an interface area 16d of the nozzle syringe 16a and the nozzle portion 16b. The interface area 16d is the area where the particles of feedstock powder 12 will tend to jam, and it is preferred that the upper end 24b of the piezoelectric element 24 is positioned at this point or possibly just a few thousands of an inch above it.

The piezoelectric element 24, in some embodiments, may be annular in shape and have a height of about 0.5 cm, an overall cross-sectional thickness of about 0.5 cm and an overall outer diameter of about 5-6 mm (assuming a nozzle portion 16b outer diameter of about 1 mm). It will be appreciated that these dimensions are just examples, and the precise configuration of the piezoelectric element 24 may vary considerably based on the requirements of a given application and the construction of the nozzle tip portion 16c. In some embodiments the piezoelectric element 24 may be secured to the nozzle portion 16b by a setscrew 25 that extends through the piezoelectric element and makes contact with an outer wall surface of the nozzle portion 16b.

The spacing of the nozzle tip 16a from the table 18 (or from a previously formed material layer portion) in some embodiments may be one or a few multiples (e.g., 1-10) of the diameter of the particles of the feedstock powder 12, and this spacing is denoted by dimension “S” in FIG. 2. In some embodiments this spacing “S” may be on the order of about 10-1000 microns, and in some embodiments more preferably between about 50-500 microns. In some embodiments the diameter of the feedstock particles may be between about 20 microns-500 microns. In some instances, the diameter of the particles of feedstock powder 12 may be about 90 microns. However, it will be appreciated that use of the system 10 is not limited to only powder particles of the above diameters, and the specific diameter selected will be due in large part to the specific construction of the nozzle being used, as well as to features or aspects of the part being formed, and possibly other considerations as well.

During a printing operation with the system 10, the feedstock powder 12 is fed via the hopper 14 to the nozzle 16. The flow rate of the feedstock powder 12 is determined in large part (and in some instances exclusively) by the nozzle portion 16b inner diameter, and in some instances in part by the friction within the hopper 12 and/or the syringe portion 16a of the nozzle 16, and in many instances by the physical properties of the feedstock powder 12 as well. At the narrowest necking point of the syringe 16a (i.e., the area 16a1 of the syringe), the powder jams and flow ceases. The piezoelectric element 24 is caused to vibrate in a “through-thickness” vibration mode. By this it is meant that the piezoelectric element 24, which in this example is a stacked piezoelectric element, is compressed along its height dimension during its construction. The vibration energy it creates will then be transmitted laterally through nozzle portion 16b in response to a 150V AC excitation signal. This disturbs the jammed powder at the interface area 16d, allowing it to flow through out through the nozzle portion 16b and onto the build table 18. The flow of the feedstock powder 12 can thus be turned fully on and off via the piezoelectric element 24, and flow rates can be controlled via the frequency of the excitation signal 20a. Accordingly, it will be appreciated that a wide variety of factors including the magnitude and frequency of the excitation signal 20a, the diameter (and possibly cross-sectional shape) of the opening at the lower end 16a1 of the nozzle 16, the properties of the feedstock powder 12 (in this example a particle size of about 90 microns), the moisture content, density, shape, etc. of the feedstock powder 12, all may affect the flow of the feedstock powder 12 out from the nozzle tip 16a. Print speeds are currently rapid at ˜10 mm/sec and feature resolution is submillimeter. The coupling of the piezoelectric element 24 to the nozzle portion 16b at the interface area 16d, or closely adjacent to it, ensures maximum vibration will be produced at the interface area 16d where the powder jamming point is typically exists.

The vibration at the nozzle portion 16b has been measured in some embodiments of the system 10 to have about a 9 micron displacement and about a 2 m/s2 acceleration. The nozzle tip 16a is lowered via the nozzle motion control subsystem 32 to a short distance above the printing substrate (a few multiples of the powders' particle size, e.g., 50-500 microns) and the piezoelectric element 24 is excited by the AC excitation signal 20a, which causes a deposition of the feedstock powder 12. The powder 12 is confined between the nozzle portion 16a and table surface 18 (or substrate surface, if a layer of powder has already been deposited), and as the nozzle 16 is moved while printing a layer of material, it scrapes and vibrates against the powder particles 12, rearranging the powder particles and compacting them. Compaction of the feedstock powder particles 12 occurs as the particles are being released and falling to the build table 18.

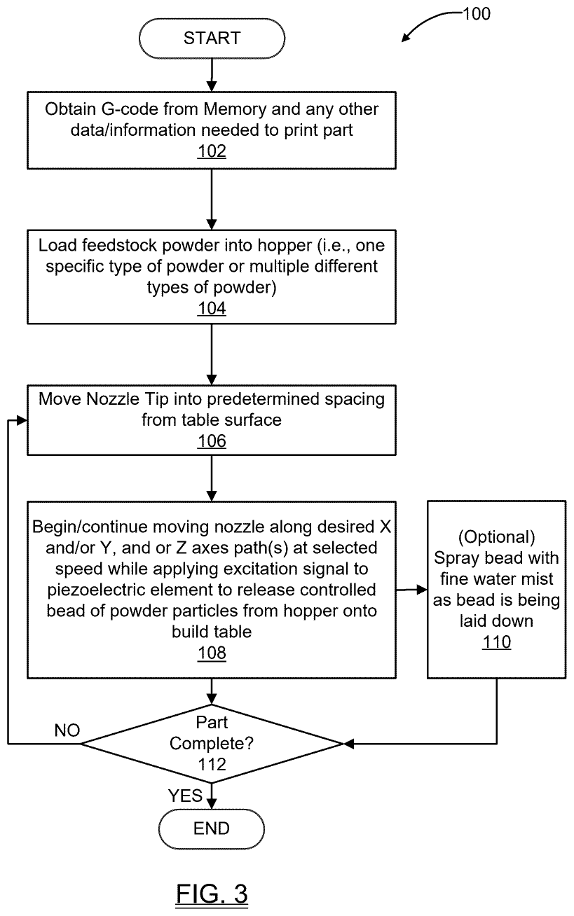

Referring briefly to FIG. 3, a flowchart 100 is shown setting forth one example of various operations that maybe performed by the system 10 in printing a 3D structure. In this example, at operation 102 the G-code needed to print the structure or part, along with any other data/information needed, is first obtained from the memory 26. At operation 104 the feedstock powder 12 is loaded into the hopper 14. At operation 106 the nozzle tip 16a is moved into the predetermined spacing from the table 18 upper surface. At operation 108 the printing begins (or continues) by moving the nozzle 16 along the desired X, Y and or Z paths at a selected speed, while applying the excitation signal from the excitation signal source 20 to the piezoelectric element 24 to controllably release the bead 27 of feedstock powder 12 onto the build table 18. At operation 110, which is operational and may not be needed with all types of powder being used (but which is helpful when printing with ceramic nano-particles), the bead 27 just laid down on the build table 18 may be sprayed with a mist of fluid, for example water. Spraying may be continuous or intermittent (e.g., pulsed at a desired repetition rate, which may depend on the characteristics of the powder being used). At operation 112 a check is made if the part is complete, and if not, operations 106-108 continue. If this check produces a “YES” answer, then printing is complete.

Tuning parameters like nozzle 16 height, deposited bead 27 spacing, and piezoelectric element 24 amplitude/frequency control the volume fraction of the deposited powder 12. At high compaction, this method produces deposited beads with vertical side-walls, allowing free-standing printed structures. The structures are robust enough for manual transport by foot, suggesting routes for further processing like sintering (e.g., by laser powder bed fusion with multiple metals with well-defined, high-resolution boundaries between deposited regions), infill with a matrix, or hot-pressing with a mold (where such a method is in demand to enable structures with variable thickness and constant porosity in pressed parts). While previous approaches have used vibration to improve flow of powders, none have used vibration to compact powder during deposition to form straight-walled beads or free-standing structures. Vibration has been applied in industrial processing of containers of powder, but the application of this principle has not been extensively studied in 3D printing, since free-standing traces of powder are uncontained, and it is difficult to apply vibration without disturbing printed structure. The nozzle 16 height and frequency that results in the highest compaction may be calibrated for a given powder. Volume fractions of printed powder can exceed the tapped density, for example, reaching up to 67 vol % for stainless steel powder. For comparison, without the confinement and vibration method, packing fraction is 61 v %, and printed lines collapse with typical angles of repose. With dense powders (e.g., stainless steel, copper and nano-sized ceramic powders), the packing fraction and thus consolidation stress and cohesive forces are high enough that freestanding vertical walls can be formed.

Lower density powders (like nano-grained ceramic powders) are more likely to collapse without vertical walls. Modulating the nozzle 16 height and in-plane spacing between printed lines controls the packing fraction, spanning a range from the lower limit (the poured/apparent density), to beyond the tapped density, and even beyond the random close-packing limit (64 v % for spheres). Surpassing this random close-packing limit indicates high consolidation force and significant forced particle rearrangements via confinement and vibration. The present disclosure recognizes that the challenge of printing vertical or near-vertical features with ceramic nano-powders, which previously required deposition at much lower density because their smaller size, has been overcome with the application of a fine water vapor stream as set forth hereinbefore. As such, ceramic nano-powders can now also be tightly packed using the system 10 and method of the present disclosure.

The general issue with flowability of nano-particles has been overcome by binding nano-particles into larger microparticles (which themselves have a density around 60 v %), using acoustic mixing in a LabRam machine. This process of making nano powder flowable enough for printing may also be valuable to protect.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A system for selective powder deposition (SPD) printing a part, comprising:
a print nozzle configured to receive powder particles, the print nozzle having a tip portion from which the powder particles are released onto a build table;
a vibrational element operably associated with the tip portion of the nozzle and configured to impart a vibrational energy into the powder particles within the print nozzle; and
an excitation subsystem configured to generate an excitation signal of a predetermined frequency, which is applied to the vibrational element, to create the vibrational energy, and wherein the vibrational energy is also imparted to the powder particles as the powder particles are being released onto the build table to compact the powder particles as the powder particles are deposited onto the build table.

2. The system of claim 1, further comprising an electronic controller for controlling the excitation subsystem.

3. The system of claim 1, wherein a lower end of the tip portion of the print nozzle is disposed within 1-10 multiples of a diameter of the powder particles of the build table during printing to assist in enabling the powder particles to be compacted before reaching the build table.

4. The system of claim 1, further comprising a fluid vaporizer for applying a fluid mist to the powder particles deposited on the build table.

5. The system of claim 1, wherein the excitation subsystem comprises an excitation subsystem for generating an alternating current (AC) excitation signal.

6. The system of claim 5, wherein the excitation signal comprises an AC signal having a frequency between about 100 Hz and 1 KHz.

7. The system of claim 6, wherein the excitation signal has a magnitude of between 100 VAC and 200 VAC.

8. The system of claim 1, wherein the vibrational element comprises a piezoelectric element.

9. The system of claim 8, wherein the piezoelectric element comprises an annular shape and is supported from the nozzle tip portion, exteriorly of the nozzle tip portion, and coaxially with the nozzle tip portion.

10. The system of claim 1, further comprising a nozzle motion control subsystem configured to control motion of the nozzle in X, Y and Z axes in response to electronic control signals from the electronic controller.

11. The system of claim 10, further comprising an electronic controller for generating electronic control signals for controlling the nozzle motion control subsystem.

12. The system of claim 2, wherein the electronic controller further comprises a memory.

13. The system of claim 12, wherein the memory stores software modules for generating G-code for printing the structure, and at least one of algorithms or data needed for printing the part.

14. A system for selective powder deposition (SPD) printing a part, comprising:
an electronic controller;
a hopper for containing a quantity of powder particles;
a print nozzle in communication with the hopper and configured to receive the powder particles, the print nozzle having a tapering syringe portion and a barrel-like, cylindrical tip portion from which the powder particles are released onto a surface of a build table;
a vibrational element operably associated with the nozzle and configured to apply vibrational energy to the powder particles contained in the nozzle to control the release of the powder particles from the nozzle tip portion;
an excitation subsystem responsive to control signals from the electronic controller, and configured to generate an excitation signal of a predetermined frequency and magnitude, which is applied to the vibrational element to cause generation of the vibrational energy; and
wherein the tip portion of the nozzle is set at a distance of about 1-10 multiples of a diameter of the powder particles from the surface of the build table, to further enable the vibrational energy to be imparted to the powder particles and compacting the powder particles as the powder particles are deposited.

15. The system of claim 14, further comprising a fluid vaporizer for applying a fluid mist to the powder particles deposited on the build table.

16. The system of claim 14, wherein the excitation subsystem comprises an excitation subsystem for generating an alternating current (AC) excitation signal.

17. The system of claim 16, wherein the excitation signal comprises an AC signal having a frequency between about 100 Hz and 1 KHz.

18. The system of claim 17, wherein the excitation signal has a magnitude of between 100 VAC and 200 VAC.

19. The system of claim 14, wherein the vibrational element comprises a piezoelectric element.

20. A method for direct ink write (DIW) printing a part, comprising:
using a print nozzle to receive powder particles to be printed on a build table to make the part;
applying an excitation signal to a vibrational element operably associated with a tip portion of the nozzle to impart vibrational energy into the powder particles contained within the print nozzle, to assist in controlling release of the powder particles from the print nozzle; and
maintaining a tip portion of the print nozzle at a predetermined distance from the build table as the nozzle is moved over the build table and deposits a bead of the powder particles, the predetermined distance being sufficiently small to enable the vibrational energy to also compact the powder particles as the powder particles are deposited onto the build table.
